(19) United States
(12) Patent Application Publication
(10) Pub. No.: US 2008/0172620 A1
(43) Pub. Date: Jul. 17, 2008

(54) WEB PAGE CONTROL PROGRAM, METHOD, AND SERVER

(75) Inventors: Katsuyoshi YOSHIMURA, Kawasaki (JP); Hiroko Sato, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/022,301

(22) Filed: Jan. 30, 2008

Related U.S. Application Data
(63) Continuation of application No. PCT/JP2005/014292, filed on Aug. 4, 2005.

(51) Int. Cl. G06F 3/01

(52) U.S. Cl. 715/760

(57) ABSTRACT

An external link receiving and responding unit of a server subjects a plurality of HTML files including file identification information to responding transmission with respect to an access request from a client by a hyperlink of a web page of another server and causes a web page composed of the plurality of HTML files to be displayed.

This application is a continuation of PCT/JP2005/014292, filed Aug. 4, 2005.

### TECHNICAL FIELD

The present invention relates to a web page control program, method, and server which implement different display contents or operations in web pages accessed by hyperlinks from a plurality of different web pages depending on the web pages of access sources and, particularly, relates to a web page control program, method, and server which implement different display contents or operations by a single HTML file depending on the web pages of the access sources.

### BACKGROUND ART

Conventionally, in creation of web sites, when the display contents or operations of the web pages accessed by hyperlinks from a plurality of different web pages have to be different depending on the contents of the web pages from which the access is made by the hyperlinks, a plurality of different web pages have to be created. Herein, basically, HTML files (source files) of the web pages in a web site are merely passed from a server to clients without change, and different HTML files are crated when the display contents or operations of the web pages are desired to be different.

FIG. 1 is a configuration diagram of a conventional web site. In a client 100, a web page 101 composed of an HTML file 102 and an HTML file 104 is displayed; and, when the contents or operations of the web pages, which are displayed by access from the HTML files 102 and 104 by hyperlinks 106 and 108, are desired to be different from each other, an HTML file 112 and an HTML file 114 which constitute respective web pages are prepared in a server 110. When display contents or operations of different web pages are desired depending on the contents of the web pages from which access is made by hyperlinks, an environment in which a CGI (Common Gateway Interface) program can be executed is prepared in the server, and the HTML files to be passed to web clients are determined or created by executing the CGI program.

FIGS. 2A and 2B show a process of a conventional web site in the case in which the CGI program is used. In FIG. 2A, the client 100 receives a response of an HTML file 116-1 through access to a server 200 having an HTML file 116 and displays a web page 118. When an access request with respect to a server 300 is performed by a hyperlink 120 of the web page 118 in this state, the server 300 executes a CGI program 302, thereby reading HTML files 304 and 306 from a database, adding keywords used as file identification information thereto, and subjecting them to responding transmission to the client 100 in order to display a web page corresponding to the hyperlink 120. FIG. 2B shows the state in which a web page 122 composed of two HTML files 304-1 and 306-1 responded from the server 300 is displayed in the client 100, wherein the keywords 124 and 126 are added to the HTML files 304-1 and 306-1, and hyperlinks 128 and 130 are provided. When the server 300 receives an access request to which the keyword 124 is added by the hyperlink 128 of the web page 122 in the client 100, the CGI program 302 reads an HTML file 308 determined by the keyword 124, reads a display definition file 310 determined by the keyword 124, creates display contents or operations of the HTML file 308 in accordance with the display definition file 310 so as to make a response to the client 100, and causes a web page corresponding to the HTML file 304-1 from which access is made by the hyperlink 128 to be displayed. Meanwhile, when the server 300 receives an access request, to which the keyword 126 is added, by the hyperlink 130 of the web page 122 in the client 100, the CGI program 302 reads the HTML file 308 determined by the keyword 126, reads a display definition file 312 determined by the keyword 126, creates display contents or operations of the HTML file 308 in accordance with the display definition file 312 so as to make a response to the client 100, and causes a web page corresponding to the HTML file 306-1 accessed by the hyperlink 130 to be displayed.

FIGS. 3A and B are time charts of a conventional web site process in the case in which the CGI program of FIGS. 2A and 2B is used. The client 100 performs an access request by a URL with respect to the server 200 in step S1, the server 200 subjects an HTML file to responding transmission in step S201, and the client 100 displays the web page thereof in step S2. Subsequently, when an access request by a hyperlink of the displayed web page is transmitted to the server 300 in step S3, in step S101, the server 300 executes the CGI program corresponding to the accessed page so as to read a plurality of HTML files, add unique keywords respectively to each HTML file, and subject them to responding transmission. The client 100 displays a web page composed of the plurality of HTML files received from the server 300 in step S4. When, with respect to this web page, an access request by a hyperlink of any of the HTML files is performed with a keyword added thereto in step S5, the server 300 executes the CGI program corresponding to the accessed page in step S102, reads an HTML file and display definition file determined based on the keyword in step S103, edits the display contents or operations of the HTML file based on the display definition file, subjects it to responding transmission, and causes a web page to be displayed in the client 100 in step S6.

However, in the conventional method in which a plurality of different web pages are created depending on the contents of web pages from which access is made by hyperlinks, a problem that HTML files are generated in the amount corresponding to the web pages of which display contents or operations are required to be different is generated, and a problem that, since the HTML files are increased, hyperlink destinations or the part to be corrected are increased and development cost or the amount of maintenance is increased is generated. Also, the method in which HTML files having different display contents or operations are created by executing a CGI program in a server needs a special environment for executing the CGI program in the server or a special environment for creating a CGI program and has a problem that development cost is increased. Also, there is a problem that the load of the web server is increased when access requests from clients are concentrated since the CGI program is executed in the web server.

### Means for Solving the Invention

According to the present invention to provide a web page control program, method, and server which change display contents or operations of a single HTML file in accordance with request sources without using a CGI program with respect to access by hyperlinks of a plurality of web pages.

(Program)

The present invention provides a web page control program executed by a computer constituting a server. The web page control program of the present invention is characterized by causing the computer constituting the server to execute:

an external link receiving and responding step of subjecting a plurality of HTML files including file identification information to responding transmission with respect to an access request from a client by a hyperlink of a web page of another server and causing a web page composed of the plurality of HTML files to be displayed;

an internal link receiving step of reading a common HTML file describing a plurality of control sentences which display different contents corresponding to the plural pieces of the file identification information and a program file which extracts the file identification information from the HTML file of a request source when an access request including the file identification information by any of the hyperlinks of the plurality of HTML files is received; and

an internal link responding step of subjecting the common HTML file and the program file to responding transmission to the client, causing the program file to be executed by the common HTML file on the client so as to retrieve the file identification information from the HTML file of request source, and selecting the control sentence of the common HTML file according to the retrieved file identification information so as to display a web page.

Herein, the file identification information respectively added to the plurality of HTML files is a predetermined keyword described in the HTML file. This keyword uses, for example, a cookie name of the HTML file.

Moreover, the control sentence described in the common HTML file is a script sentence which controls the display contents and/or operations according to the file identification information.

Moreover, the program file is a script file describing a script sentence which reads the file identification information from the HTML file of request source.

(Method)

The present invention provides a web page control method executed by the computer constituting the server. The web page control method of the present invention is characterized by causing the computer constituting the server to execute:

an external link receiving and responding step of subjecting a plurality of HTML files including file identification information to responding transmission with respect to an access request from a client by a hyperlink of a web page of another server and causing a web page composed of the plurality of HTML files to be displayed;

an internal link receiving step of reading a common HTML file describing a plurality of control sentences which display different contents corresponding to the plural pieces of the file identification information and a program file which extracts the file identification information from the HTML file of a request source when an access request including the file identification information by any of the hyperlinks of the plurality of HTML files is received; and

an internal link responding step of subjecting the common HTML file and the program file to responding transmission to the client, causing the program file to be executed by the common HTML file on the client so as to retrieve the file identification information from the HTML file of request source, and selecting the control sentence of the common HTML file according to the retrieved file identification information so as to display a web page.

(Server)

The present invention provides a server. The server of the present invention is characterized by having:

an external link receiving and responding unit which subjects a plurality of HTML files including file identification information to responding transmission with respect to an access request from a client by a hyperlink of a web page of another server and causes a web page composed of the plurality of HTML files to be displayed;

an internal link receiving unit which reads a common HTML file describing a plurality of control sentences which display different contents corresponding to the plural pieces of the file identification information and a program file which extracts the file identification information from the HTML file of a request source when an access request including the file identification information by any of the hyperlinks of the plurality of HTML files is received; and

an internal link responding unit which subjects the common HTML file and the program file to responding transmission to the client, causes the program file to be executed by the common HTML file on the client so as to retrieve the file identification information from the HTML file of request source, and selecting the control sentence of the common HTML file according to the retrieved file identification information so as to display a web page.

Note that details of the web page control method and the server according to the present invention are basically same as the case of the web page control program according to the present invention.

### EFFECTS OF THE INVENTION

According to the present invention, the common HTML file composed of a single HTML file changes display contents or operations of a web page in accordance with the web page of a request source from which access is made by a hyperlink and displays a different web page; therefore, the HTML files of the server are not required to be increased, and development cost or the amount of maintenance of the web site built in the server can be reduced.

Moreover, since a CGI program is not used, a special environment for executing the CGI program in the web server or a special environment for creating a CGI program are not required to be prepared, the development cost of the web site built in the server is reduced, and the load of the web server can be reduced even when access requests from clients are concentrated.

### BRIEF DESCRIPTION OF DRAWINGS

FIG. 1 is an explanatory diagram of a conventional web site which separately creates HTML files every time display contents or operations of web pages are different;

FIGS. 2A and 2B are explanatory diagrams of a process of a conventional web site which creates web pages of different display contents or operations by using a CGI program;

FIGS. 3A and 3B are time charts of a conventional web site process of FIGS. 2A and 2B;

FIG. 4 is an explanatory diagram of a network environment to which the present invention is applied;

FIGS. 5A and 5B are block diagrams showing a functional configuration of a server which builds web page control of the present invention together with a client;

FIG. 6 is a block diagram of a hardware environment of a computer which constitutes the server of FIGS. 5A and 5B;

FIGS. 7A, 7B, 8A and 8B are explanatory diagrams of a process operation of web page control according to the present invention;

FIG. 9 is an explanatory diagram of a description example in an HTML file including a keyword;

FIG. 10 is an explanatory diagram of a script file used in the present invention;

FIG. 11 is an explanatory diagram of a common HTML file used in the preset invention which retrieves a keyword by executing the script file of FIG. 10 and changes display contents or operations;

FIGS. 12A and 12B are time charts of a process operation of web page control according to the present invention;

FIGS. 13A and 13B are flow charts of a server process of the present invention which performs web page control; and

FIGS. 14A and 143 are flow charts of a client process involved in the server process of FIGS. 13A and 13B.

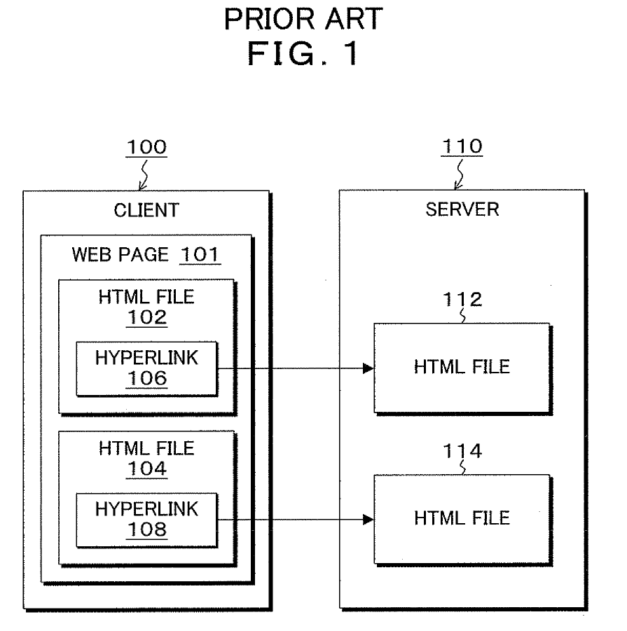

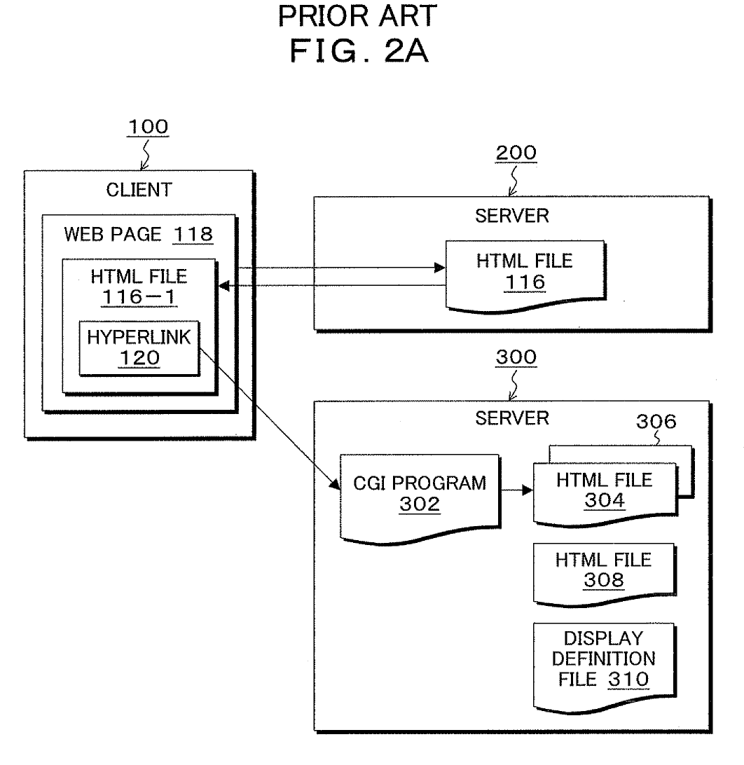

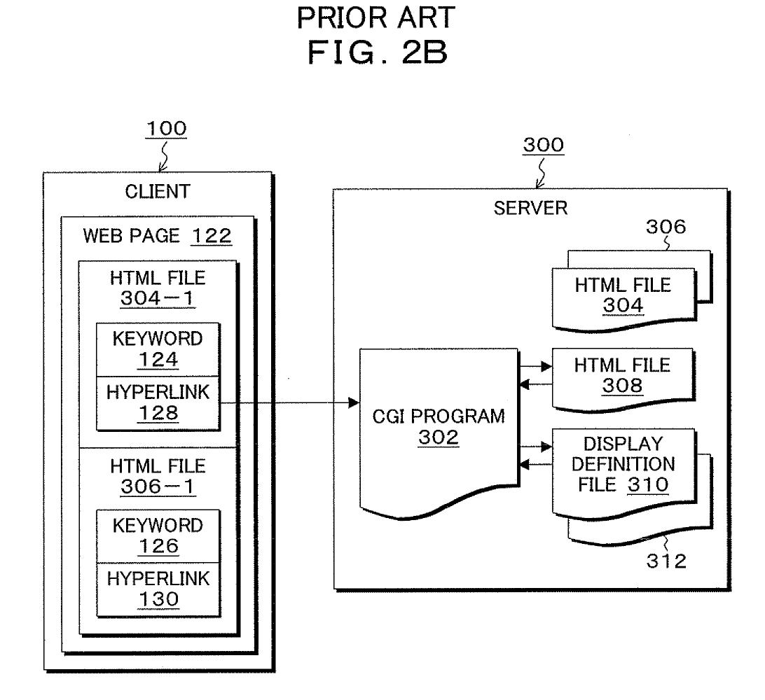

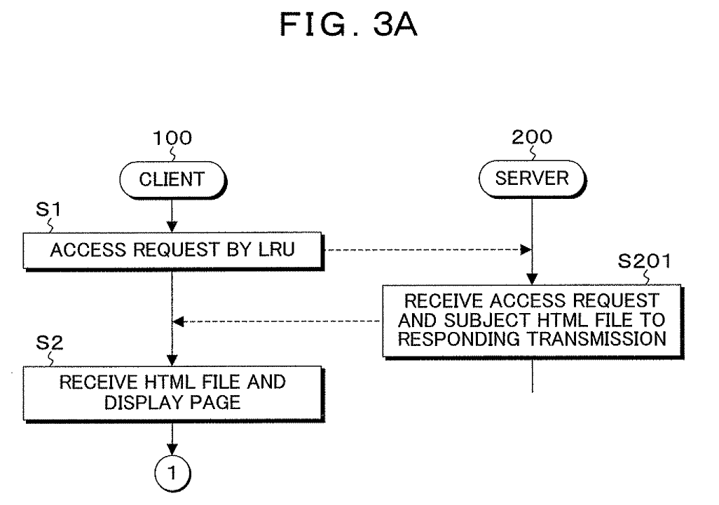

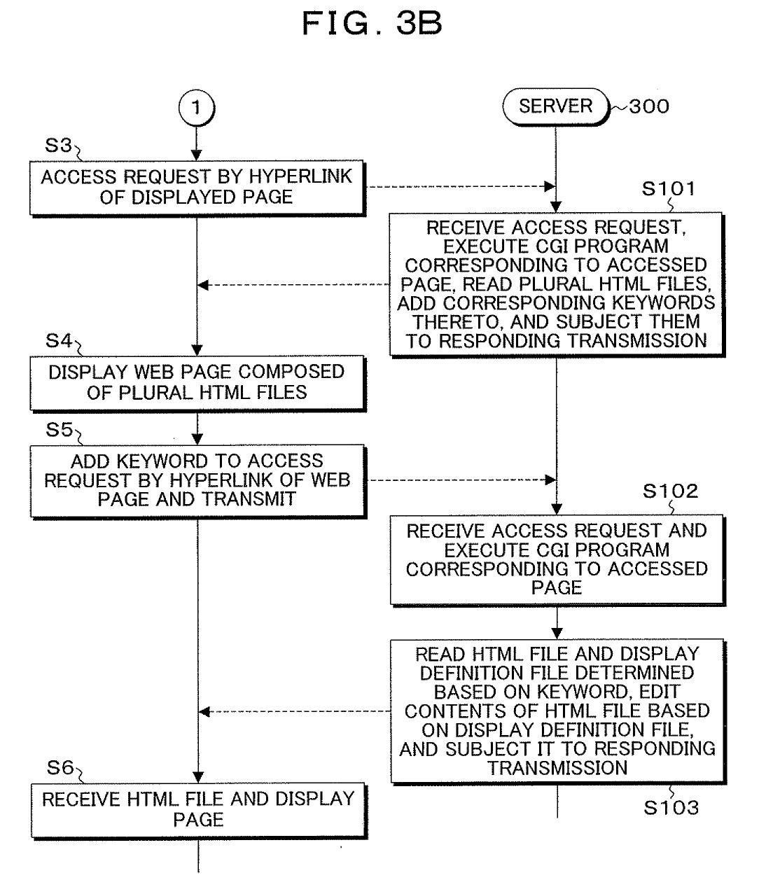

### BEST MODE FOR CARRYING OUT THE INVENTION

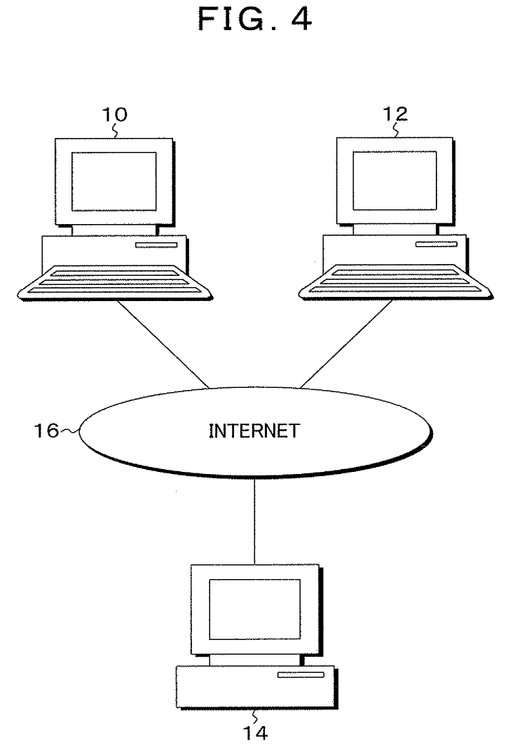

FIG. 4 is an explanatory diagram of a network environment to which web page control of the present invention is applied. In FIG. 4, a server 10 and a server 12 build web sites and respectively crate and save source files, i.e., HTML files for displaying web pages. A client 14 is connected to the servers 10 and 12 via Internet 16, and the client 14 can access the respective web sites and browse web pages by specifying URLs of the server 10 and 12. In such a network environment for browsing web pages, the servers 10 and 12 are called as web servers; however, they will be referred to as servers in the explanation hereinafter for simplicity. Also, the client 14 is also called as a web client; however, it is simply referred to as a client for simplicity in the explanation hereinafter. In FIG. 4, web page control according to the present invention is applied to the server 10, and, on the other hand, the server 12 performs normal web page control. Furthermore, the number of clients is an arbitrary number in accordance with needs.

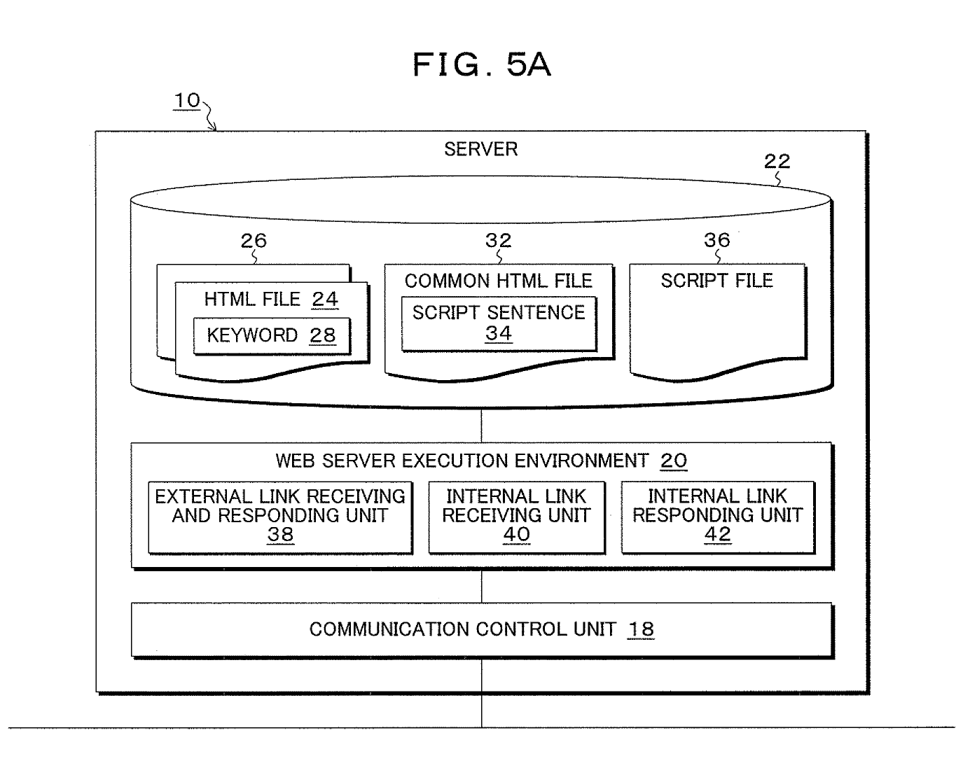

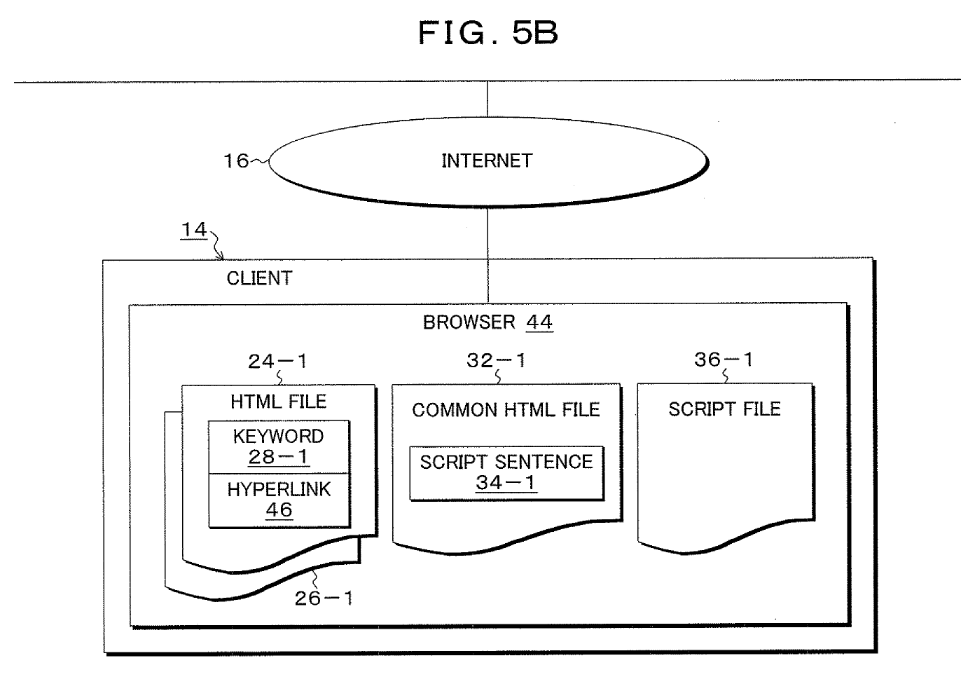

FIGS. 5A and 5B are explanatory diagrams showing a functional configuration of the server building web pages of the present invention together with the client. In FIGS. 5A and 5B, in the server 10, a communication control unit 18, a web server execution environment 20, and a database 22 are provided. In the database 22, HTML files 24 and 26 are stored; and, in this embodiment, responses are made by the two HTML files 24 and 26 with respect to access requests by hyperlinks from the client side, and web pages composed of the HTML files 24 and 26 are caused to be displayed. In the HTML files 24 and 26, keywords 28 and 30 (keyword 30 is not shown) used as file identification information are set in advance. As the keywords 28 and 30 used as this file identification information, for example, cookie names described in the HTML files 24 and 26 can be used. Also, in the database 22, a common HTML file 32 and a script file 36 are stored. The common HTML file 32 is a single HTML file which can change the display contents or operations of web pages by script sentences 34, which are control sentences described therein, and cause different web pages to be displayed. In the script sentences 34 of this common HTML file 32, script sentences that change the display contents or operations based on keywords which are file identifiers of the HTML files serving as access request sources by hyperlinks are described respectively every keyword. In this embodiment, with respect to a hyperlink of any of the HTML files of the web pages on the client side composed of the two HTML files 24 and 26 provided in the database 22 of the server 10, the script sentences 34 of the common HTML file 32 are executed based on the keywords of the access request sources so that web pages of different display contents or operations are displayed. Therefore, in the script sentences 34, a script sentence that reads and executes the keyword 28 of the HTML file 24 and a script sentence that reads and executes the keyword 30 (not shown) of the HTML file 26 are described. The script file 36 is a program file that retrieves the keyword of the HTML file of the access request source used by the script sentence 34 described in the common HTML file 32. The common HTML file 32 and the script file 36 saved in the database 22 are subjected to a receiving response based on the keyword added to an access request from the client 14 by the hyperlink, and they are executed in the client 14 and can cause web pages of display contents or operations corresponding to the file of the access request source by the hyperlink to be displayed. In the web server execution environment 20, an external link receiving and responding unit 38, an internal link receiving unit 40, and an internal link responding unit 42 are provided. For example with respect to access requests by hyperlinks when a web page of the other server 12 shown in FIG. 4 is displayed in the client 14, the external link receiving and responding unit 38 reads the HTML files 24 and 26 having the keywords 28 and 30 from the database 22, subjects them to responding transmission to the client 14, and causes web pages composed of the HTML files 24 and 26 to be displayed. When an access request including the keyword 28-1 as file identification information by any of hyperlinks of HTML files 24-1 and 26-1 stored in the client 14 through responding transmission of the HTML files 24 and 26, for example, a hyperlink 46 of an HTML file 24-1 is received, the internal link receiving unit 40 executes a process of reading the common HTML file 32 and the script file 36 from the database 22 to correspond to the keyword 28-1. The internal link responding unit 42 transmits the common HTML file 32 and the script file 36 read by the internal link receiving unit 40 based on the keyword 28-1 obtained through the access request by the hyperlink 46 to the client 14 and causes a browser 44 of the client 14 to store and execute them as a common HTML file 32-1 and a script file 36-1. The browser 44 of the client 14 retrieves the keyword 28-1 by the script file 36-1 from the HTML file 24-1, which is the access request source by the hyperlink 46, and sets and executes this keyword 28-1 in a corresponding script sentence 34-1 of the common HTML file 32-1, thereby displaying a web page according to the common HTML file 32-1 having display contents or operations described in the script sentence 34-1 on the client 14. When, with respect to the web page composed of the HTML file 24-1 which has undergone responding transmission from the server 12 to the browser 44, an access request by a hyperlink 48 (not shown) provided in the other HTML file 26-1 is performed with a keyword 30-1 (not shown) thereof added thereto, similarly, the common HTML file 32-1 and the script file 36-1 are subjected to responding transmission from the server 10 on the client 14 and executed by the browser 44 of the client 14. In this case, the browser 44 of the client 14 retrieves the keyword 30-1 of the other HTML file 26-1 serving as the access request source by the script file 36-1 and sets it in the script sentence 34-1, thereby executing the script sentence 34-1 corresponding to the keyword 30-1; thus, the display contents or operations of the common HTML file 32-1 can be changed, and a web page different from that of the access by the hyperlink 46 of the HTML file 24-1 can be displayed in the client 14.

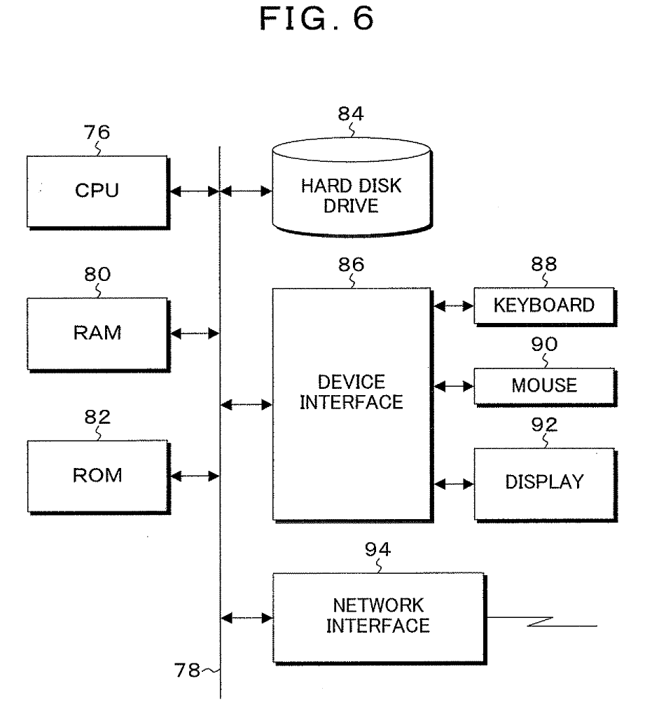

FIG. 6 is a block diagram of a hardware environment of a computer which constitutes the server 10 of FIGS. 5A and 5B. In FIG. 6, a RAM 80; a ROM 82; a hard disk drive 84; a device interface 86 connecting a keyboard 88, a mouse 90, and a display 92; and a network interface 94 are connected to a bus 78 of a CPU 76. A web page control program of the present invention is stored in a hard disk drive 84 and, when the computer is activated, read from the hard disk drive 84 and deployed to the RAM 80; and, when this is executed by the CPU 76, a web page control function according to the present invention is realized.

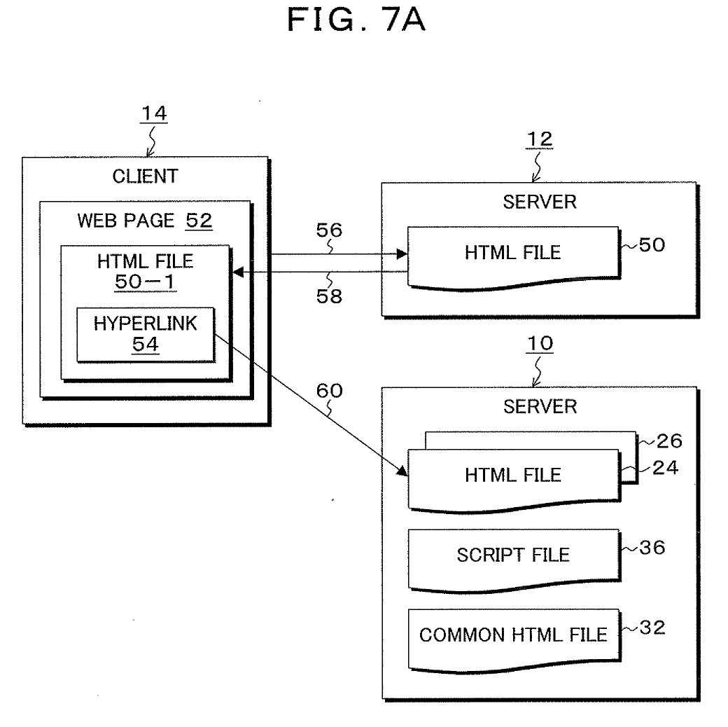

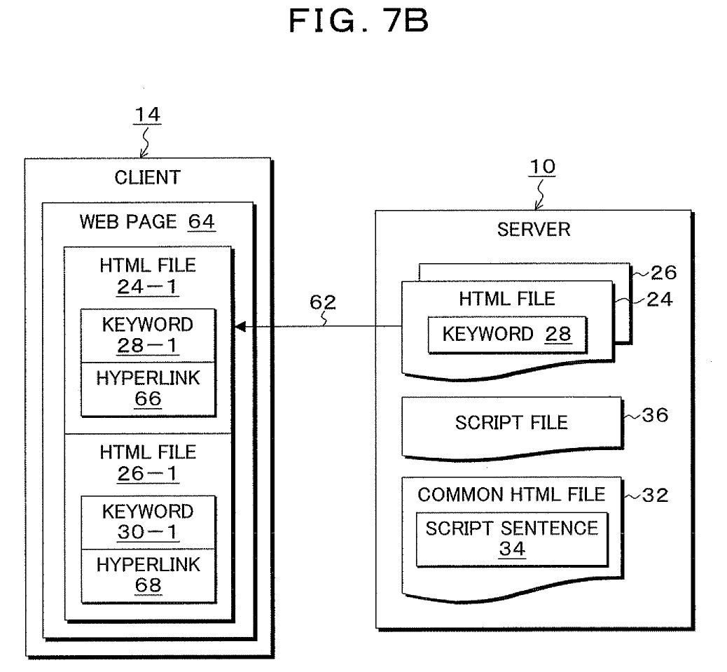

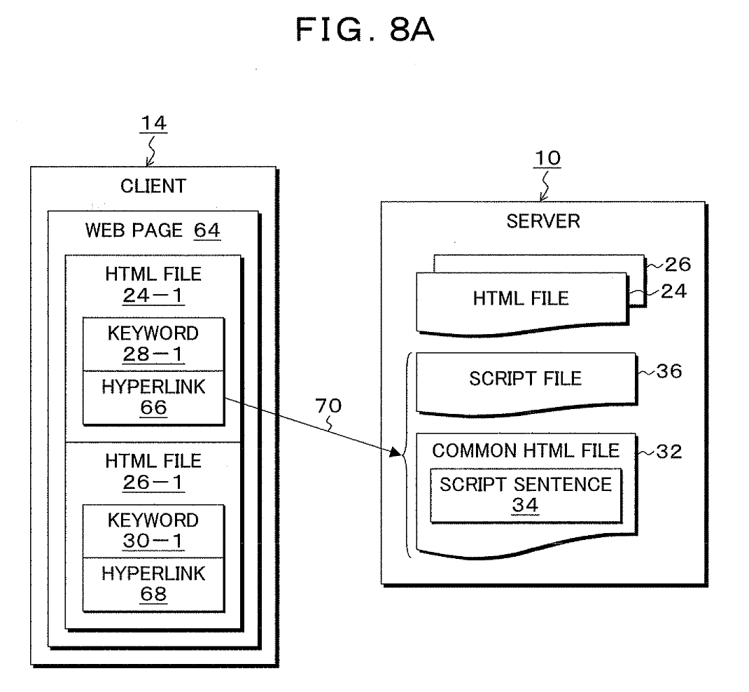

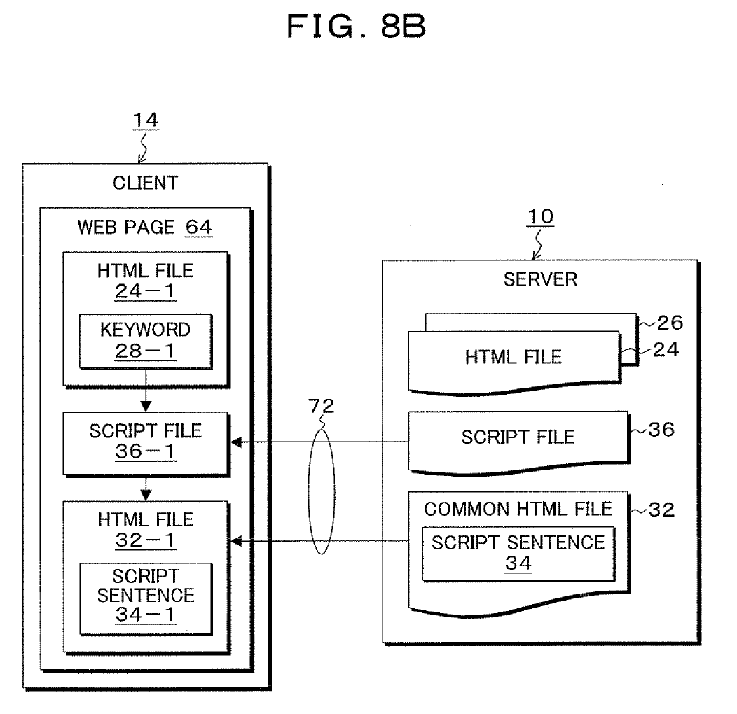

FIGS. 7A, 7B, 8A, and 8B are explanatory diagrams showing processing operations of web page control according to the present invention separately in four steps of FIGS. 7A, 7B, 8A, and 8B. In FIG. 7A, in the network environment as shown in FIG. 4, the client 14 performs an access request 56 to the server 12 by specifying a URL, and, in response to responding transmission 58 of an HTML file 50 of the server 12, a web page 52 according to an HTML file 50-1 is displayed. In this web page 52, a hyperlink 54 is disposed. When the hyperlink 54 is operated, for example mouse-clicked, in the client 14, an access request 60 by the hyperlink 54 is performed with respect to the server 10. This can be considered as an access request of an external hyperlink since it is an access request of the hyperlink of the other server 12 when viewed from the server 10. As shown in FIG. 7B, the server 10 which has received the access request 60 from the client 14 by the external hyperlink 54 reads the HTML files 24 and 26 from the database to correspond to the access request by the hyperlink, respectively adds the keywords 28 and 30 (not shown) thereto, and subjects them to responding transmission 62 to the client 14. As a result, the HTML files 24-1 and 26-1 which have undergone responding transmission from the server 10 are stored in the client 14, and a web page 64 composed of the two HTML files 24-1 and 26-1 are displayed. Herein, the keyword 28-1 is added to the HTML file 24-1 transmitted from the server 10, and the keyword 30-1 is also added to the HTML file 26-1. Furthermore, hyperlinks 66 and 68 are respectively provided in the HTML files 24-1 and 26-1. It is assumed that an access request 70 is performed, for example as shown in FIG. 5A in the state of FIG. 7B, by operating, for example, mouse-clicking the hyperlink 66 of the HTML file 24-1. Based on the access request 70, the server 10, which has received the access request 70 by the hyperlink 66, determines and reads the common HTML file 32 from the database and determines and reads the script file 36. Then, as shown in FIG. 8B, the read common HTML file 32 and script file 36 are subjected to responding transmission 72 to the client 14. In the browser of the client 14, which has received the responding transmission 72 from the server 12, the keyword 28-1 is retrieved from the HTML file 24-1, which is the access request source, by executing the transmitted script file 36-1, and a corresponding sentence is selected from the script sentences 34-1 of the common HTML file 32-1 according to the keyword 28-1 and executed, thereby creating and displaying a web page of display contents or operations corresponding to the hyperlink 66 of the HTML file 24-1, which is the access request source, from the common HTML file. Meanwhile, when an access request by the hyperlink 68 of the other HTML file 26-1 is performed in the state of FIG. 7B, similarly, the common HTML file 32 and the script file 36 are read and subjected to responding transmission to the browser of the client 14 as shown in FIG. 8B.

The browser of the client 14 retrieves the keyword 30-1 of the HTML file 26-1 as the access request source by executing the script file 34-1 and selects and executes the corresponding part in the script sentences 34-1 corresponding to the retrieved keyword 30-1, thus, a web page having another display contents or operations corresponding to the hyperlink 68 of the HTML file 26-1, which is the access request source, can be displayed.

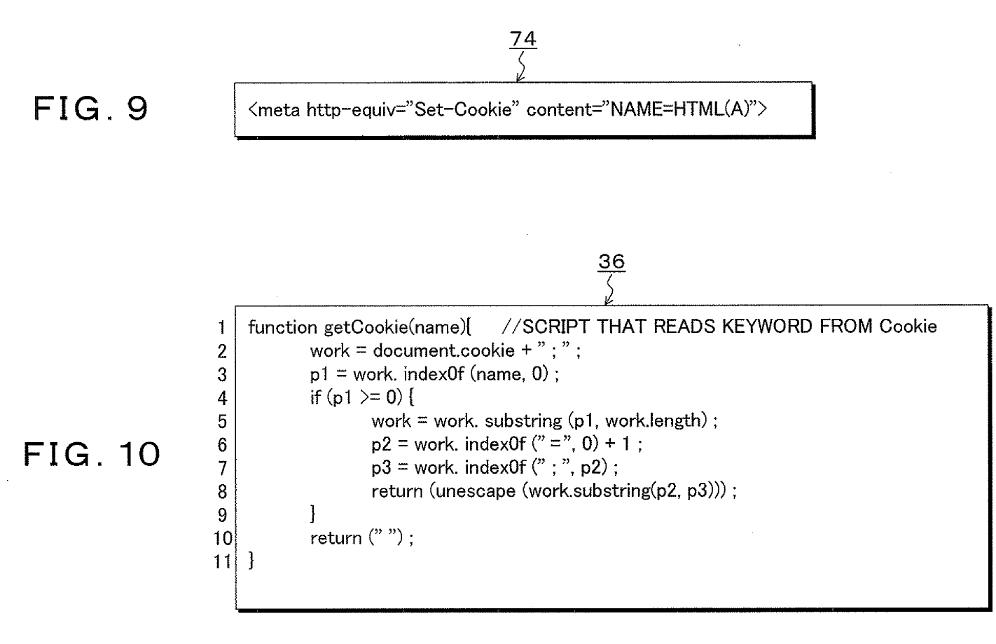

FIG. 9 is an explanatory diagram of a description example including a keyword in the HTML files used in the present invention, wherein “NAME=HTML (A)” described in a cookie sentence 74 in the HTML file is, for example, the keyword 28 of the HTML file 24 of FIGS. 5A and 5B. On the other hand, “NAME=HTML (B)” similarly described in a cookie sentence 74 can be used as the keyword 30 of another HTML file 26 of FIGS. 5A and 5B.

FIG. 10 is an explanatory diagram of source sentences of the script file 36 used in the present invention. In FIG. 10, in the script file 36, script sentences that retrieve the keyword 28 from the cookie sentence 74 shown in FIG. 9 are described.

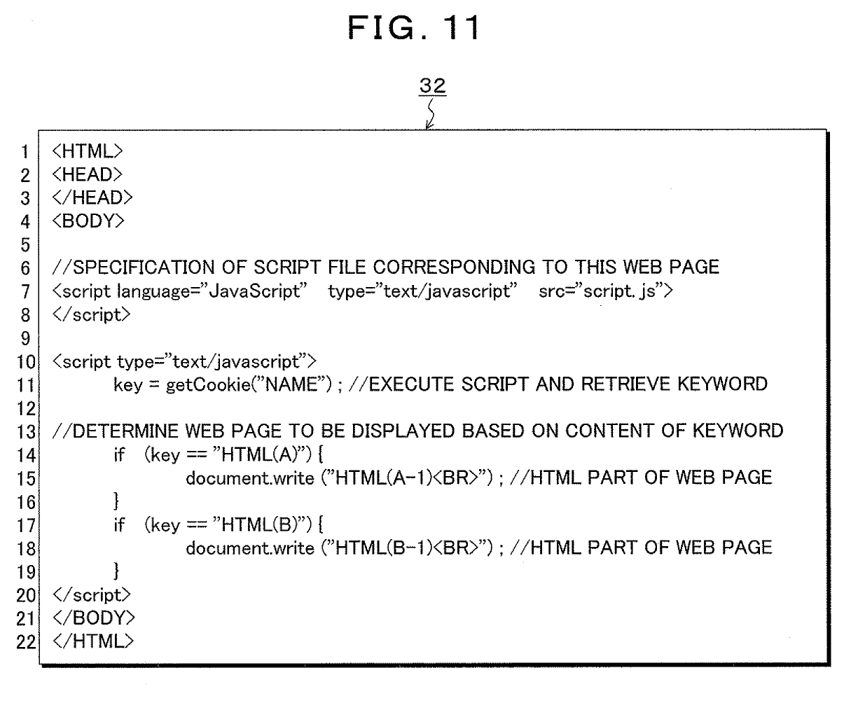

FIG. 11 is an explanatory diagram of source sentences of the common HTML file 32 used in the present invention. In FIG. 11, in the common HTML file 32, script sentences for changing display contents or operations are described in 8th to 20th lines, and the 10th to 11th lines among them are source sentences that retrieve a keyword by execution of the script file 36 of FIG. 10. When the script file 36 of this source sentences are executed, and a keyword is retrieved from the cookie sentence of FIG. 9, selective display of a web page corresponding to the retrieved keyword is performed by the next script sentences of the 13th to 19th lines. Specifically, the 14th to 16th lines are If sentences selected by the keyword “HTML (A)”, “HTML=(A−1)” which is an HTML file corresponding to the keyword “HTML=(A)” is selected by this, and the contents thereof are displayed as a web page. Meanwhile, when the keyword “HTML=(B)” is retrieved, “HTML=(B−1)”, which is another HTML file, is read by the If sentences of the 17th to 19th lines, and a web page of different display contents or operations is displayed. As a matter of course, the script file 36 and the common HTML file 32 are subjected to responding transmission from the server 10 to the client 14 and executed by the browser of the client. With respect to an access request by a hyperlink, the server 10 merely reads the corresponding common HTML file 32 and script file 36 and subjects them to responding transmission.

The execution of the script file 36 and the common HTML file 32 for changing the contents or operations of the web page is carried out on the browser of the client; therefore, load of web page control in the server 10 side is significantly reduced. In the server 10, the single common HTML file 32 is prepared with respect to the plurality of HTML files serving as access request sources by hyperlinks, and the common HTML file 32 is merely required to add, for example, the script sentences of the 14th to 16th lines and the 17th to 19th lines of FIG. 11 corresponding to the number of the HTML files serving as access request sources by the hyperlinks, i.e., the number of keywords; and, even when the number of the HTML files of the access request sources by the hyperlinks that require change in display contents is increased, the capacity of the common HTML file 32 in the server 10 is kept small, and the man-hours of development when web pages are to be built or the amount of maintenance during operation can be significantly reduced. Moreover, since a CGI program is not used in the server 10 side, a server environment for executing a CGI program or development operations therefor is not required, and the operation load and cost of development and maintenance of web sites can be significantly reduced.

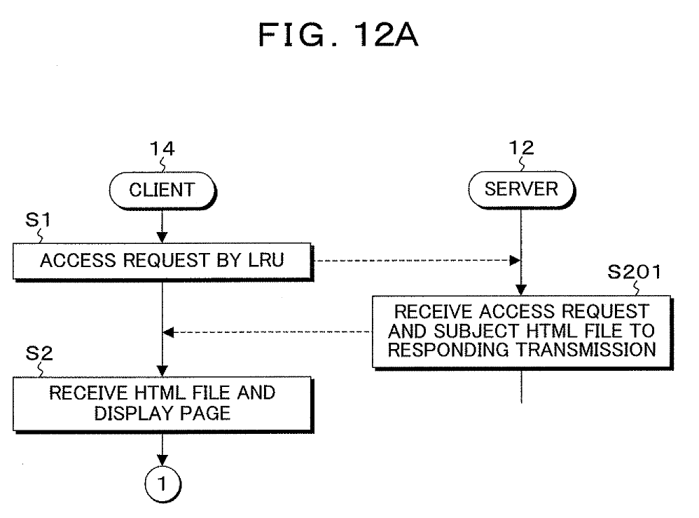

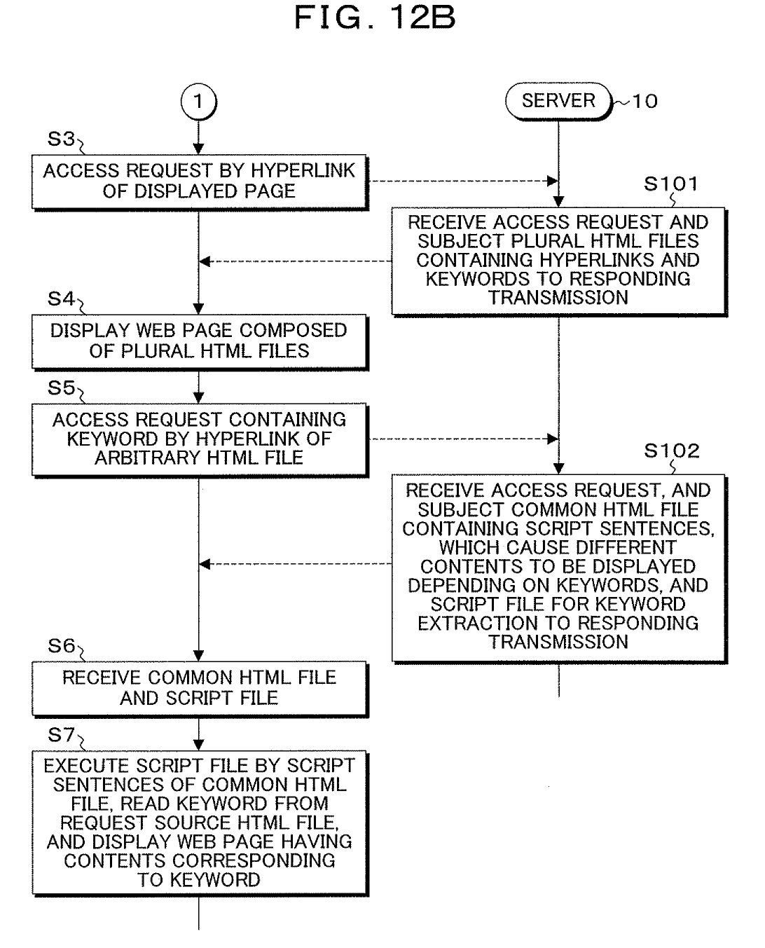

FIGS. 12A and 12B are time charts of a processing operation of web control of the present invention, and it will be as the following when explained with reference to FIGS. 5A and 5B. In FIGS. 12A and 12B, the client 14 performs an access request by a URL with respect to, for example, the server 12 shown in FIG. 4 in step S1, in response to this, the server 12 subjects an HTML file to responding transmission in step S201, and the client 14 displays a web page in step S2. When the client 14 performs an access request with respect to the server 10 by a hyperlink of the displayed page in this state in step S3, the server 10 receives the access request and subjects a plurality of HTML files including hyperlinks and keywords to responding transmission in step S101. In response to this responding transmission, the client 14 displays a web page composed of the plurality of HTML files in step S4. Subsequently, the client 14 performs an access request with respect to the server 10 by a hyperlink of an arbitrary HTML file in step S4. In response to this, the server 10 subjects the common HTML file 32 including the script sentences for implementing different display contents or operations depending on the received access request and the script file 36 for retrieving the keyword to responding transmission in step S102. The client 14 which has received the responding transmission from the server 10 receives the common HTML file 32 and the script file 36 in step S6 and, in step S7, executes the script file 36 according to the script sentences of the common HTML file, thereby reading the keyword from the HTML file of request source and displaying a web page of the contents corresponding to the keyword.

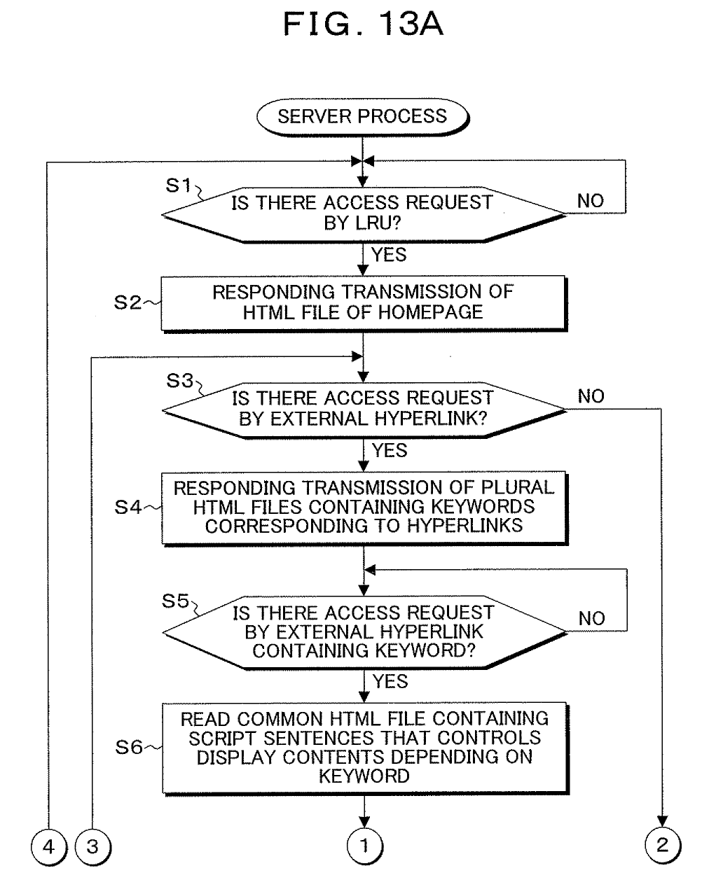

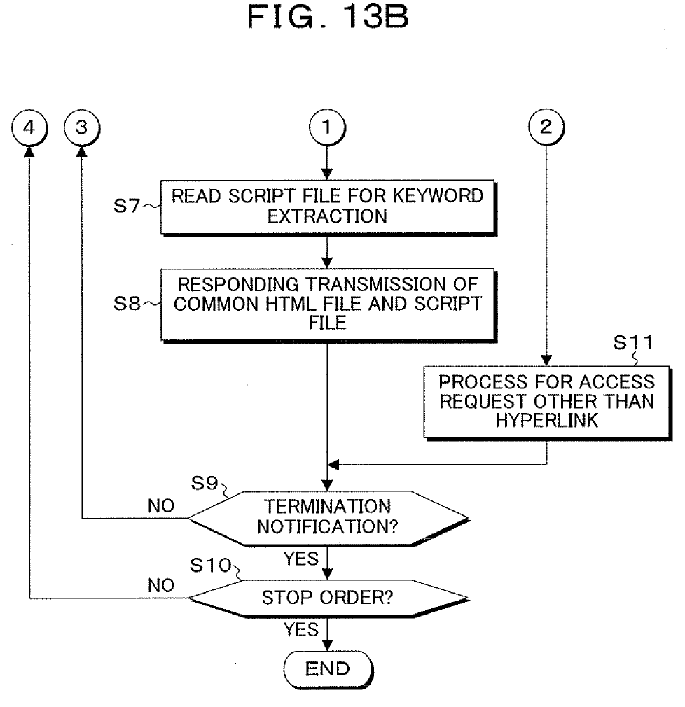

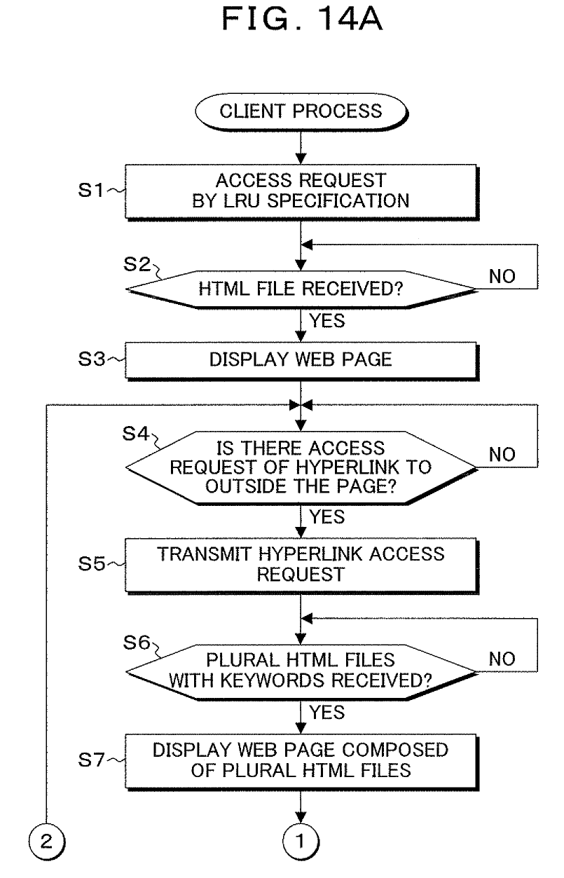

FIGS. 13A and 138 are flow charts of a server process of the present invention which performs control of web pages, and, at the same time, shows a processing procedure of a server dedicated program provided by the present invention. In FIGS. 13A and 13B, in the server process, presence or absence of an access request by a URL is checked in step S1, and, if there is the access request by the URL, an HTML file of a homepage is subjected to responding transmission in step S2 so as to display it on the client side. This is a process as a normal web site. In addition to that, presence or absence of an access request by an external hyperlink from another server is checked in step S3, and, when the access request by the external hyperlink is determined, the process proceeds to step S4 wherein a plurality of HTML files including keywords corresponding to hyperlinks are subjected to responding transmission and displayed on the client.

Subsequently, presence or absence of an access request by an internal hyperlink is checked in step S5, and, when it is determined, a common HTML file including a script sentence which controls display contents in accordance with an access request is read in step S6. Subsequently, a script file for keyword extraction is read in step S7, and the read common HTML file and script file are subjected to responding transmission in step S8. Subsequently, the process from step S3 is repeated until there is a termination notification in step S9. When there is an access request other than the external hyperlink, for example, a path request for page transition in step 53, a process for an access request other than a hyperlink is executed in step S11. Such a series of processes is repeated until there is a stop order in step S10.

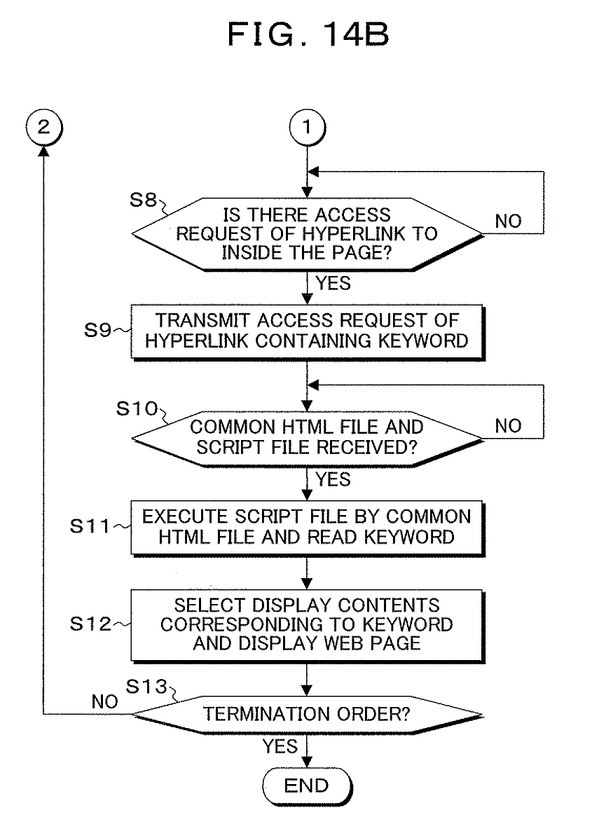

FIGS. 14A and 14B are flow charts of a client process involved in the server process of FIGS. 13A and 13B. This client process is a process executed by a browser for browsing web pages installed in the client itself, and a special program is not required to be installed. In FIGS. 14A and 14B, in the client process, when an access request by a URL is performed in step S1, and when reception of the HTML file with respect to this is determined in step S2, a web page is displayed in step S3. This is a normal browsing process of a web site.

Subsequently, an access request of a hyperlink to outside the page of the currently displayed web page is determined in step S4, a hyperlink access request is transmitted in step S5, and reception of the plurality of HTML files with keywords is waited for in step S6. When the HTML files are received in step S6, a web page composed of the plurality of HTML files is displayed in step S7.

Subsequently, presence or absence of an access request of a hyperlink to within the page is checked in step S8, and, when there is the access request, an access request of the hyperlink to which the access request is performed is transmitted to the server in step S9. When reception of the common HTML file 32 and the script file 36 from the server is determined with respect to this access request in step S10, the script file is executed by the common HTML file, and the keyword of the HTML file serving as the access request source is read in step S11. In step S12, display contents or operations are implemented by selective execution of the script sentences of the common HTML file corresponding to the keyword so as to display a web page. Such a process is repeated until there is a termination order in step S13.

Note that the present invention includes arbitrary modifications that do not impair the objects and advantages of the present invention, and the present invention is not limited by the numerical values shown in the above described embodiment.

1. A computer-readable storage medium which stores a web page control program causing a computer constituting a server to execute:
an external link receiving and responding step of subjecting a plurality of HTML files including file identification information to responding transmission with respect to an access request from a client by a hyperlink of a web page of another server and causing a web page composed of the plurality of HTML files to be displayed;
an internal link receiving step of reading a common HTML file describing a plurality of control sentences which display different contents and/or operations corresponding to the plural pieces of the file identification information and a program file which extracts the file identification information from the HTML file of a request source when an access request including the file identification information by any of the hyperlinks of the plurality of HTML files is received; and
an internal link responding step of subjecting the common HTML file and the program file to responding transmission to the client, causing the program file to be executed by the common HTML file on the client so as to retrieve the file identification information from the HTML file of request source, and selecting the control sentence of the common HTML file according to the retrieved file identification information so as to display a web page.

2. The storage medium according to claim 1, wherein that the file identification information is a predetermined keyword described in the HTML file.

3. The storage medium according to claim 1, wherein that the keyword is a cookie name of the HTML file.

4. The storage medium according to claim 1, wherein that the control sentence described in the common HTML file is a script sentence which controls the display contents and/or operations according to the file identification information.

5. The storage medium according to claim 1, wherein that the program file is a script file describing a script sentence which reads the file identification information from the HTML file of request source.

6. A web page control method causing a computer constituting a server to execute:
an external link receiving and responding step of subjecting a plurality of HTML files including file identification information to responding transmission with respect to an access request from a client by a hyperlink of a web page of another server and causing a web page composed of the plurality of HTML files to be displayed;
an internal link receiving step of reading a common HTML file describing a plurality of control sentences which display different contents corresponding to the plural pieces of the file identification information and a program file which extracts the file identification information from the HTML file of a request source when an access request including the file identification information by any of the hyperlinks of the plurality of HTML files is received; and
an internal link responding step of subjecting the common HTML file and the program file to responding transmission to the client, causing the program file to be executed by the common HTML file on the client so as to retrieve the file identification information from the HTML file of request source, and selecting the control sentence of the common HTML file according to the retrieved file identification information so as to display a web page.

7. The web page control method according to claim 6, wherein that the file identification information is a predetermined keyword described in the HTML file.

8. The web page control method according to claim 7, wherein that the keyword is a cookie name of the HTML file.

9. The web page control method according to claim 6, wherein that the control sentence described in the common HTML file is a script sentence which controls the display contents and/or operations according to the file identification information.

10. The web page control method according to claim 6, wherein that the program file is a script file describing a script sentence which reads the file identification information from the HTML file of request source.

11. A server having:
an external link receiving and responding unit which subjects a plurality of HTML files including file identification information to responding transmission with respect to an access request from a client by a hyperlink of a web page of another server and causes a web page composed of the plurality of HTML files to be displayed;
an internal link receiving unit which reads a common HTML file describing a plurality of control sentences which display different contents corresponding to the plural pieces of the file identification information and a program file which extracts the file identification information from the HTML file of a request source when an access request including the file identification information by any of the hyperlinks of the plurality of HTML files is received; and
an internal link responding unit which subjects the common HTML file and the program file to responding transmission to the client, causes the program file to be executed by the common HTML file on the client so as to retrieve the file identification information from the HTML file of request source, and selecting the control sentence of the common HTML file according to the retrieved file identification information so as to display a web page.

12. The server according to claim 11, wherein the file identification information is a predetermined keyword described in the HTML file.

13. The server according to claim 12, wherein the keyword is a cookie name of the HTML file.

14. The server according to claim 11, wherein the control sentence described in the common HTML file is a script sentence which controls the display contents and/or operations according to the file identification information.

15. The server according to claim 11, wherein the program file is a script file describing a script sentence which reads the file identification information from the HTML file of request source.
